(19) United States
(12) Patent Application Publication
(10) Pub. No.: US 2022/0297135 A1
(43) Pub. Date: Sep. 22, 2022

(54) SYSTEM FOR GRINDING MATERIAL INCORPORATING MACHINE LEARNING

(71) Applicants: ROY OLSON, SIOUX FALLS, SD (US); JOSHUA TRACY, HARRISBURG, SD (US); ALEX PEARSON, SIOUX FALLS, SD (US)

(72) Inventors: ROY OLSON, SIOUX FALLS, SD (US); JOSHUA TRACY, HARRISBURG, SD (US); ALEX PEARSON, SIOUX FALLS, SD (US)

(21) Appl. No.: 17/690,155

(22) Filed: Mar. 9, 2022

Related U.S. Application Data
(60) Provisional application No. 63/162,607, filed on Mar. 18, 2021.

(51) Int. Cl. B02C 25/00; B02C 4/02; G05B 13/02

(52) U.S. Cl. CPC B02C 25/00; B02C 4/02; G05B 13/027

(57) ABSTRACT

A system may comprise a grinding apparatus configured to receive material and produce the output material, and a control apparatus configured to control operation of elements of the system. The control apparatus may include an operational interface assembly configured to provide an operational interface for the system, a sensor assembly configured to sense operational characteristics of elements of the system, an actuating assembly configured to operate elements of the system, and a processing device configured to receive input from the operational interface assembly and the sensor apparatus assembly and send output to the actuating assembly. The processing device may be configured to apply an analytical structure to input received by the processing device and to generate output to affect operation of the elements of the system.

### REFERENCE TO RELATED APPLICATIONS

This application claims the priority benefit of U.S. Provisional Patent Application No. 63/162,607, filed Mar. 18, 2021, which is hereby incorporated by reference in its entirety.

### BACKGROUND

### Field

The present disclosure relates to grinding or milling apparatus and more particularly pertains to a new system for grinding material incorporating machine learning to providing a grinding apparatus with abilities to improve the operation and longevity of the apparatus and the quality of the product output.

### SUMMARY

In one aspect, the present disclosure relates to a system which may include a grinding apparatus configured to receive material and produce the output material, and the grinding apparatus may comprise a frame, at least one pair of rolls, a plurality of roll supports configured to support the at least one pair of rolls on the frame, and at least one rotation motor configured to rotate at least one of the rolls of the at least one pair of rolls. The system may further include a control apparatus configured to control operation of elements of the system, and the control apparatus may comprise an operational interface assembly configured to provide an operational interface for the system, a sensor assembly configured to sense operational characteristics of elements of the system to produce machine data, the sensor assembly being configured to sense physical characteristics of the material processed by the system to produce material data, an actuating assembly configured to operate elements of the system, and a processing device configured to receive input from the operational interface assembly and the sensor apparatus assembly and send output to the actuating assembly. The processing device may be configured to apply an analytical structure to input received by the processing device and to generate output to affect operation of the elements of the system.

There has thus been outlined, rather broadly, some of the more important elements of the disclosure in order that the detailed description thereof that follows may be better understood, and in order that the present contribution to the art may be better appreciated. There are additional elements of the disclosure that will be described hereinafter and which will form the subject matter of the claims appended hereto.

In this respect, before explaining at least one embodiment or implementation in greater detail, it is to be understood that the scope of the disclosure is not limited in its application to the details of construction and to the arrangements of the components, and the particulars of the steps, set forth in the following description or illustrated in the drawings. The disclosure is capable of other embodiments and implementations and is thus capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present disclosure. It is important, therefore, that the claims be regarded as including such equivalent constructions insofar as they do not depart from the spirit and scope of the present disclosure.

The advantages of the various embodiments of the present disclosure, along with the various features of novelty that characterize the disclosure, are disclosed in the following descriptive matter and accompanying drawings.

### BRIEF DESCRIPTION OF THE DRAWINGS

The disclosure will be better understood and when consideration is given to the drawings and the detailed description which follows. Such description makes reference to the annexed drawings wherein:

FIG. 1 is a schematic perspective view of a grinding apparatus of new system according to the present disclosure.

FIG. 2 is a schematic side sectional view of a scalper assembly of the grinding apparatus of the system, according to an illustrative embodiment.

FIG. 3 is a schematic side sectional view of a feed apparatus of the grinding apparatus of the system, according to an illustrative embodiment.

FIG. 4 is a schematic side view of the adjustment structure of the grinding apparatus isolated from other elements of the grinding apparatus, according to an illustrative embodiment.

FIG. 5 is a schematic diagram of elements of the control apparatus of the system, according to an illustrative embodiment.

FIG. 6 is a schematic diagram of the operational interface assembly of the control apparatus of the system, according to an illustrative embodiment.

FIG. 7 is a schematic diagram of the sensor assembly of the control apparatus of the system, according to an illustrative embodiment.

FIG. 8 is a schematic diagram of the actuating assembly of the control apparatus of the system, according to an illustrative embodiment.

FIG. 9 is a schematic flow diagram of the material flow through various elements of the system, according to an illustrative embodiment.

FIG. 10 is a schematic flow diagram of the data/information flow through various elements of the system, according to an illustrative embodiment.

FIG. 11A is a schematic diagram of the spatial relationship of the diagrams shown in FIGS. 11B through 11D depicting the data/information architecture of elements of the control apparatus of the system, according to an illustrative implementation.

FIG. 11B is a schematic diagram of portions of the flow of data/information with respect to elements of the control apparatus of the system, according to an illustrative implementation.

FIG. 11C is a schematic diagram of further portions of the flow of data/information with respect to elements of the control apparatus of the system, according to an illustrative implementation.

FIG. 11D is a schematic diagram of additional portions of the flow of data/information with respect to elements of the control apparatus of the system, according to an illustrative implementation.

FIG. 12 is a schematic diagram representative of data movement through an artificial neural network (ANN) of the system, according to an illustrative implementation.

FIG. 13 is a schematic diagram showing data/information movement from a plurality of systems to a central model training server and refinements of the model moving back to the systems, according to an illustrative implementation.

FIG. 14A is a schematic diagram of the spatial relationship of the diagrams shown in FIGS. 14B through 14D depicting the data/information architecture of elements of the artificial neural network (ANN) model of the control apparatus of the system, according to an illustrative implementation.

FIG. 14B is a schematic diagram of portions of the flow of data/information with respect to elements of the ANN model of the control apparatus of the system, according to an illustrative implementation.

FIG. 14C is a schematic diagram of further portions of the flow of data/information with respect to elements of the ANN model of the control apparatus of the system, according to an illustrative implementation.

FIG. 14D is a schematic diagram of additional portions of the flow of data/information with respect to elements of the ANN model of the control apparatus of the system, according to an illustrative implementation.

FIG. 15 is a schematic diagram representative of data movement through a random forest (RF) model of the system, according to an illustrative implementation.

FIG. 16A is a schematic diagram of the spatial relationship of the diagrams shown in FIGS. 16B through 16D depicting the data/information architecture of elements of the artificial neural network (ANN) model of the control apparatus of the system, according to an illustrative implementation.

FIG. 16B is a schematic diagram of portions of the flow of data/information with respect to elements of the RF model of the control apparatus of the system, according to an illustrative implementation.

FIG. 16C is a schematic diagram of further portions of the flow of data/information with respect to elements of the RF model of the control apparatus of the system, according to an illustrative implementation.

FIG. 16D is a schematic diagram of additional portions of the flow of data/information with respect to elements of the RF model of the control apparatus of the system, according to an illustrative implementation.

FIG. 17 is a schematic diagram of an information sharing structure with respect to multiple system, according to an illustrative implementation.

### DETAILED DESCRIPTION

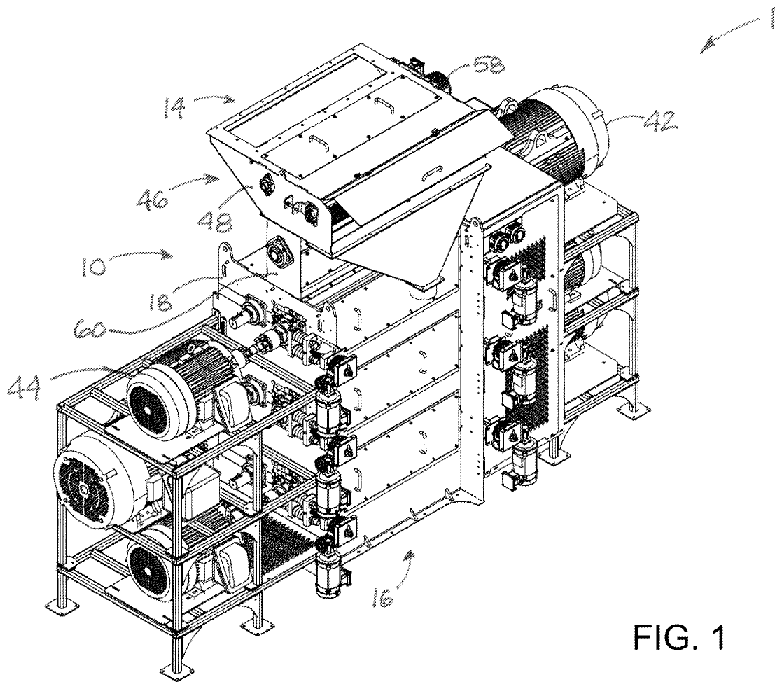

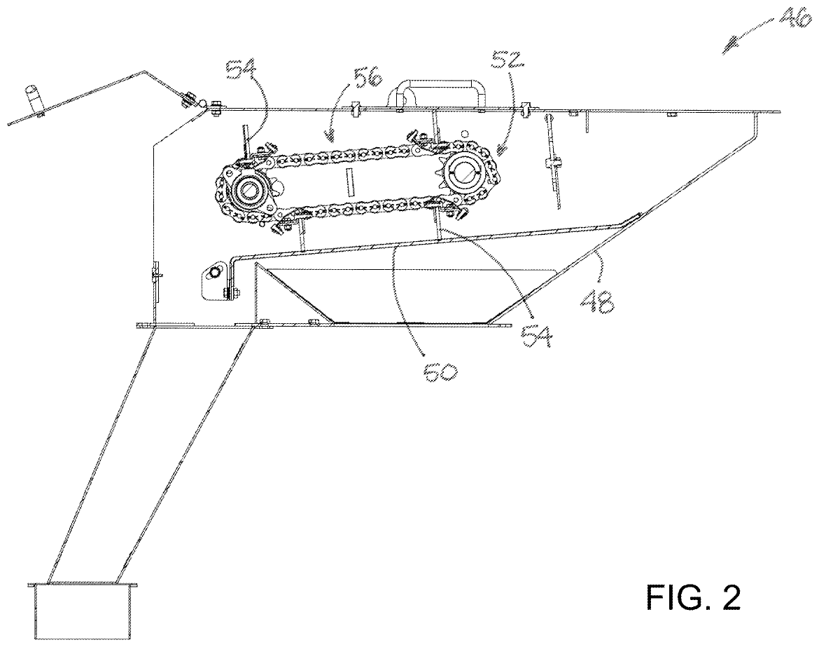

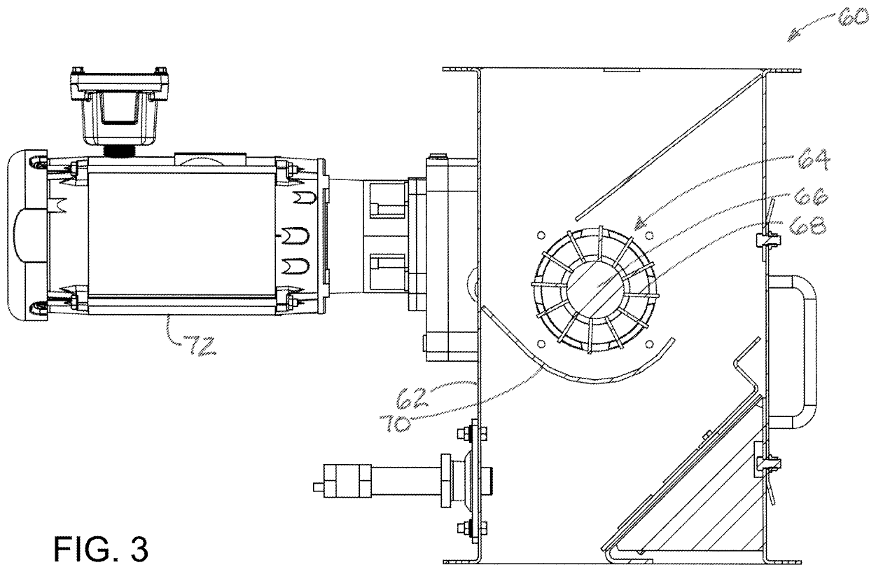

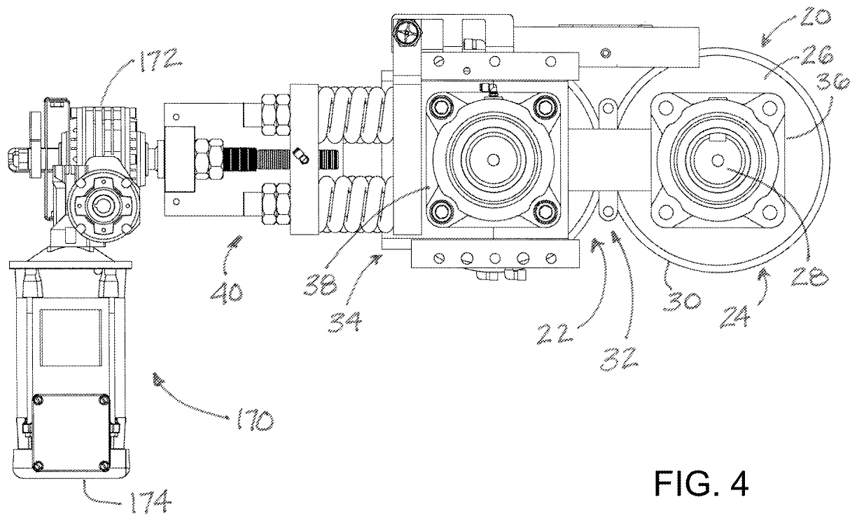

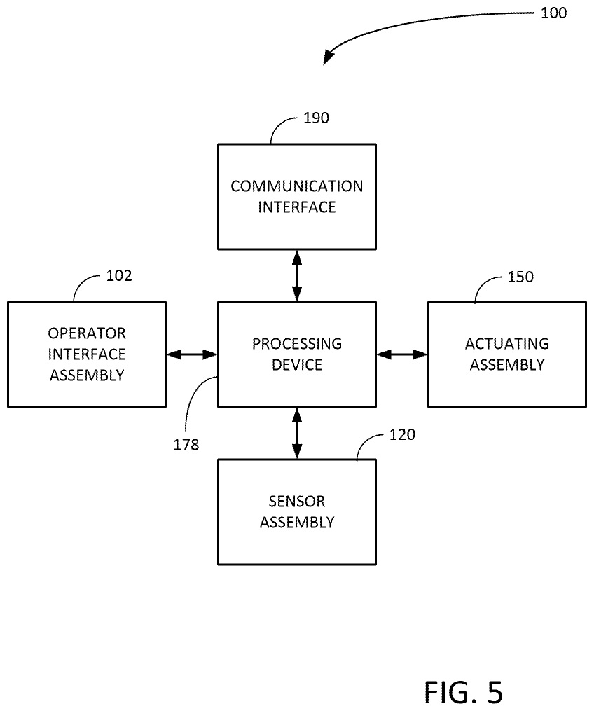

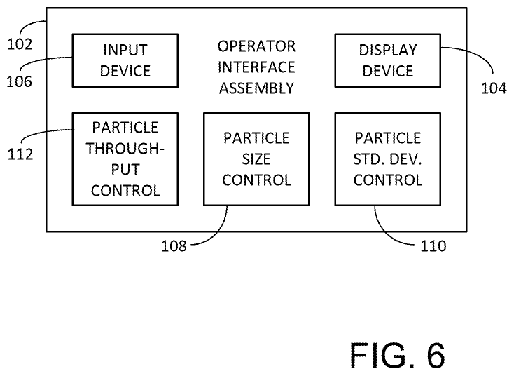

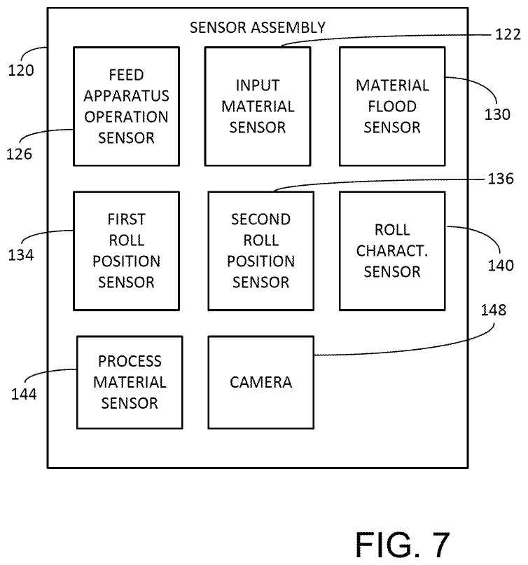

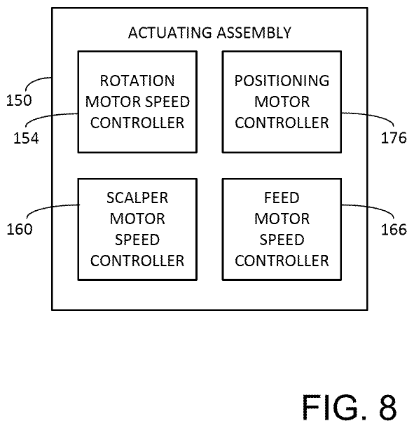

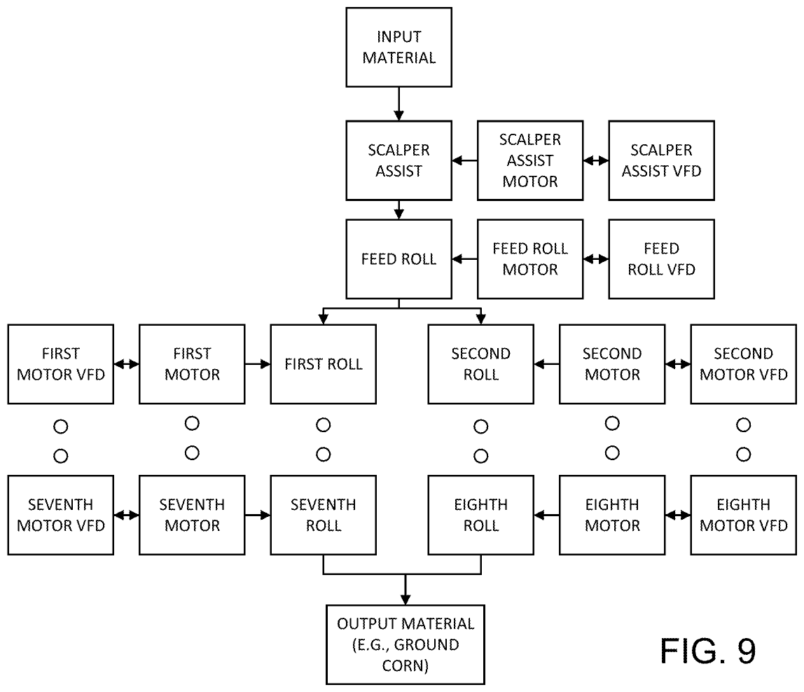

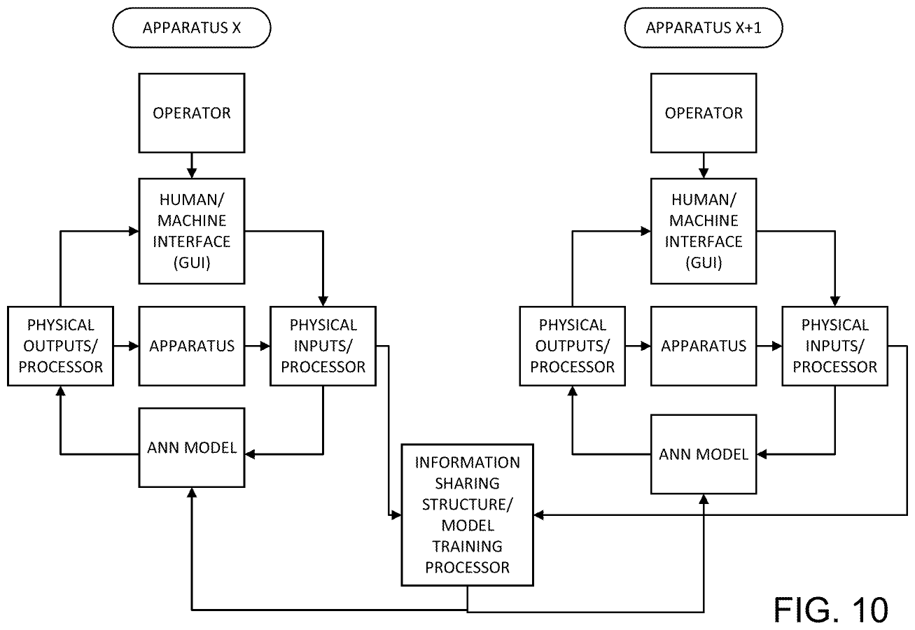

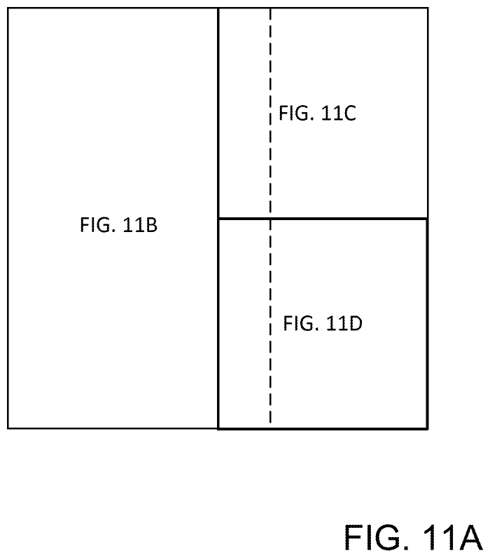

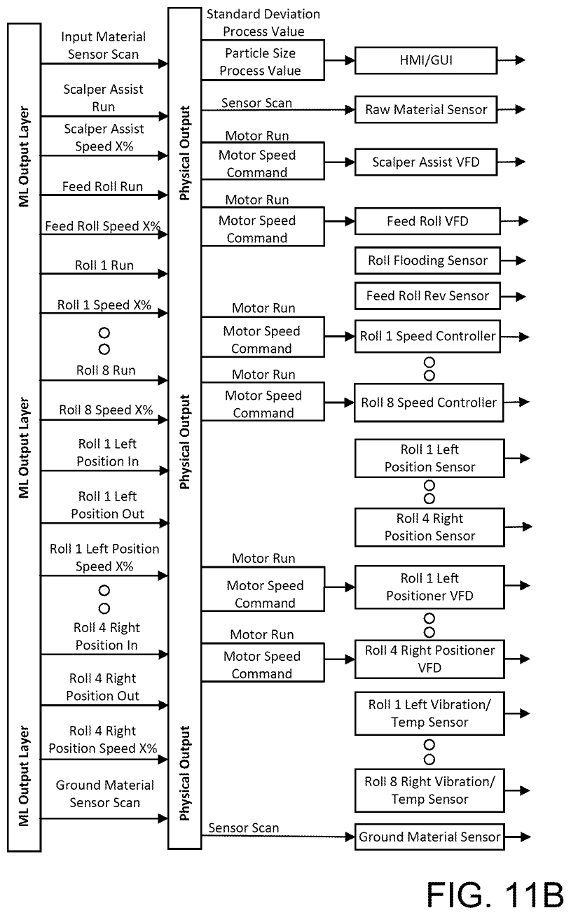

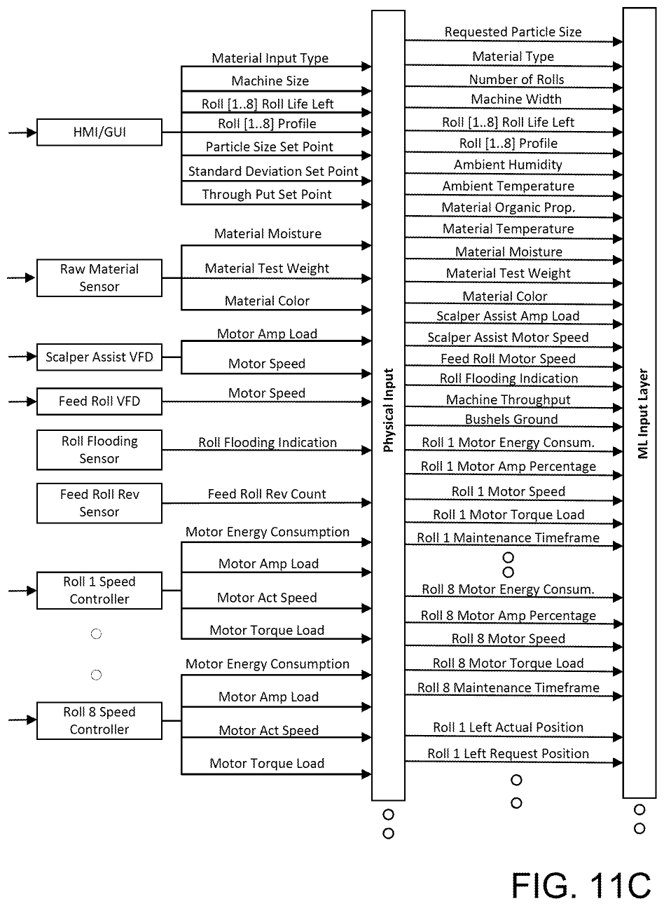

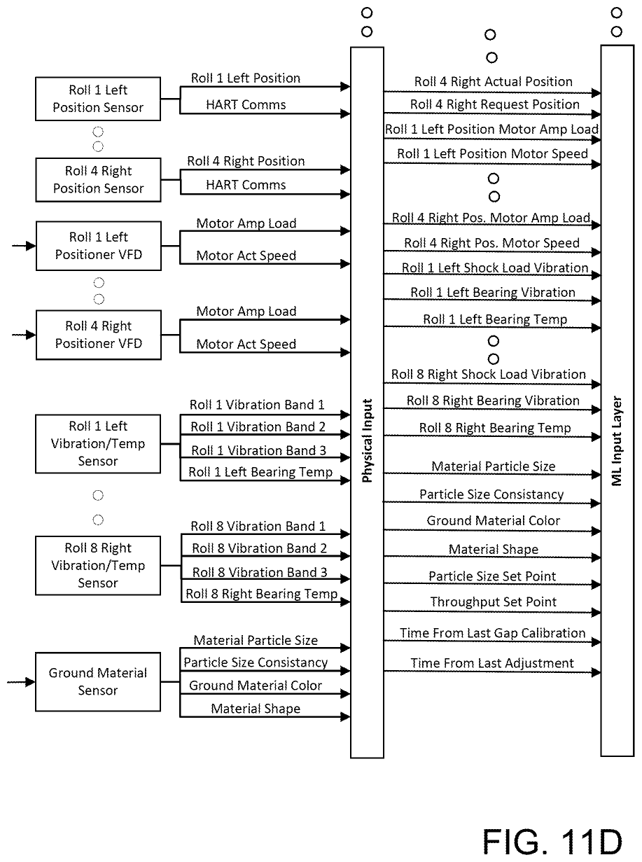

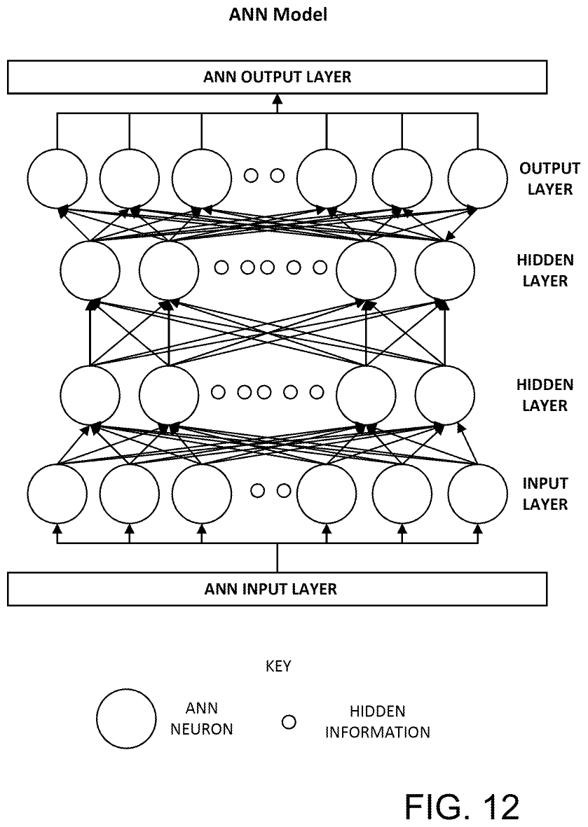

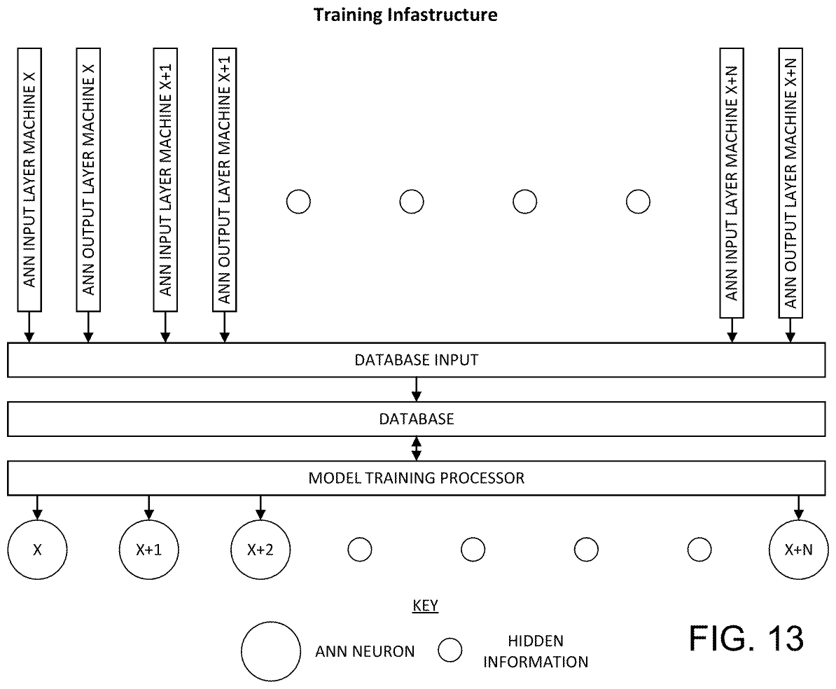

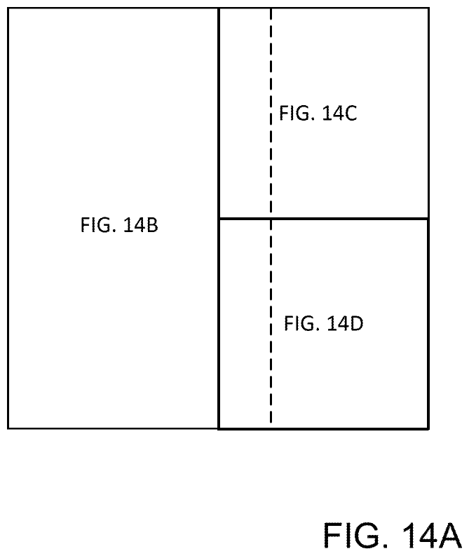

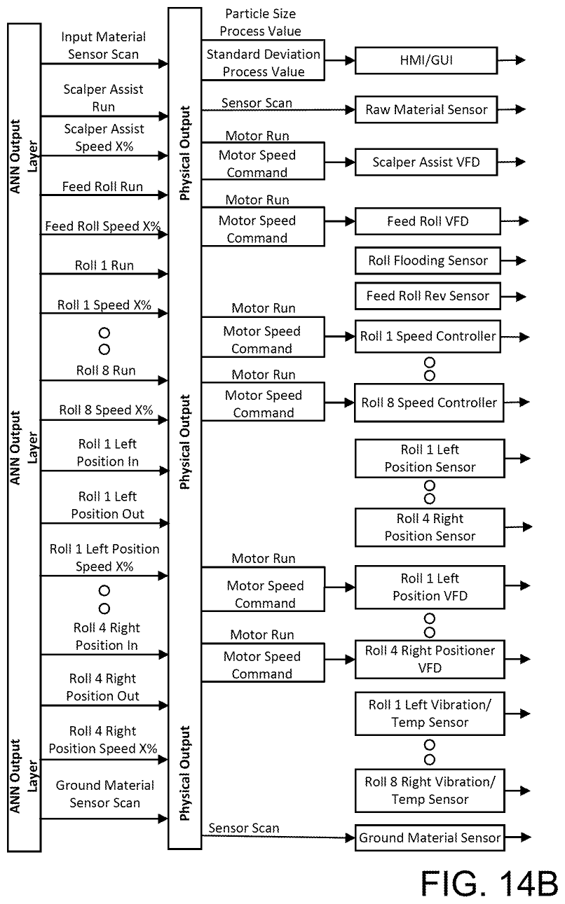

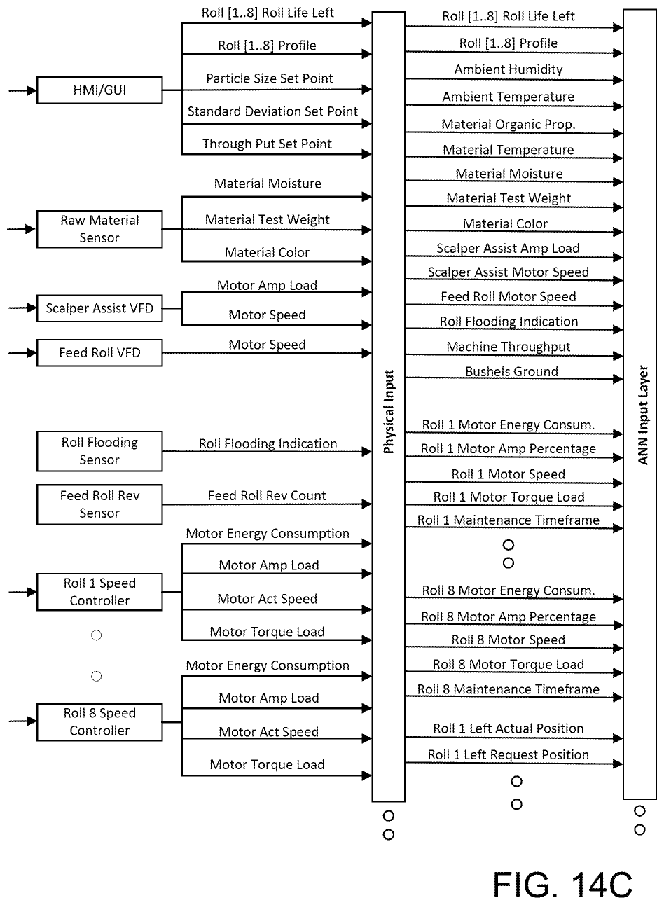

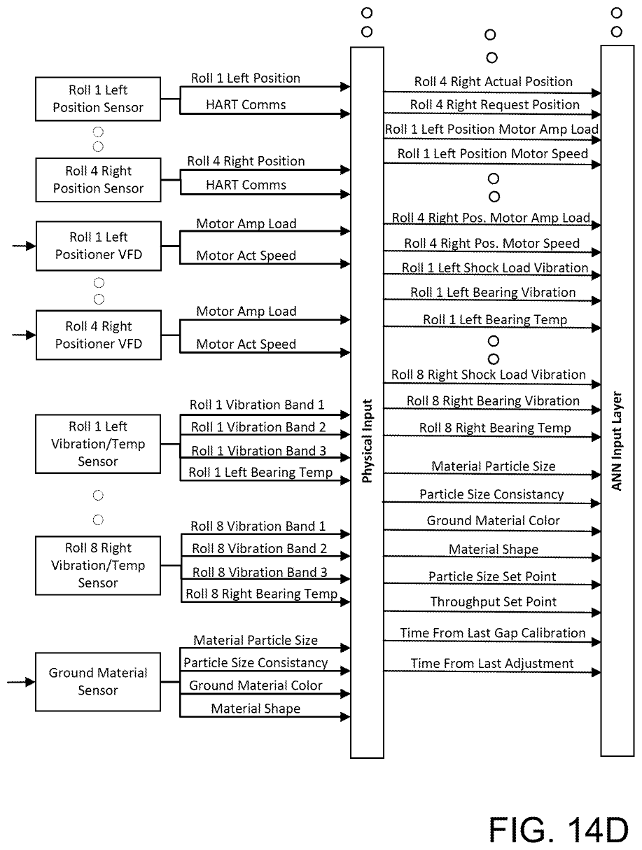

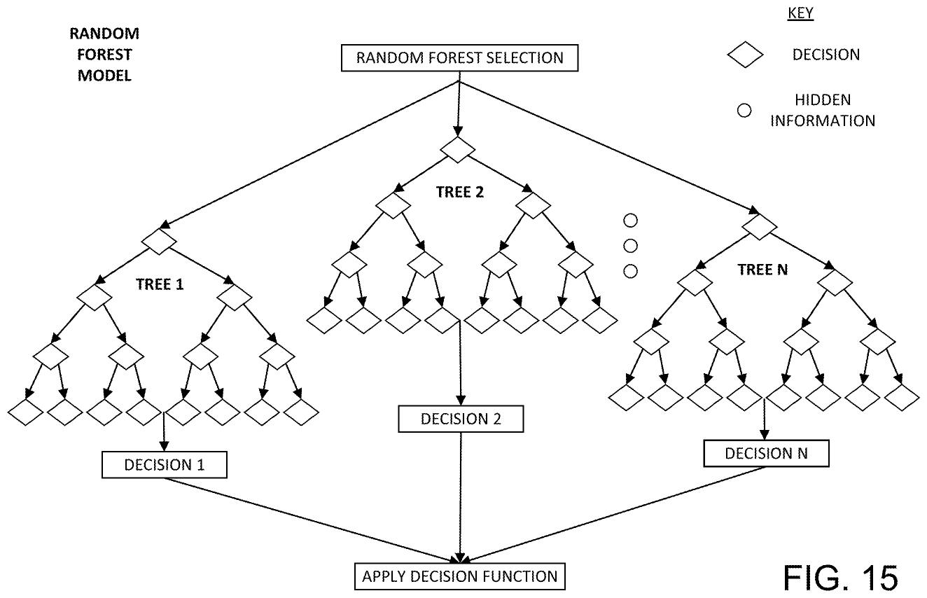

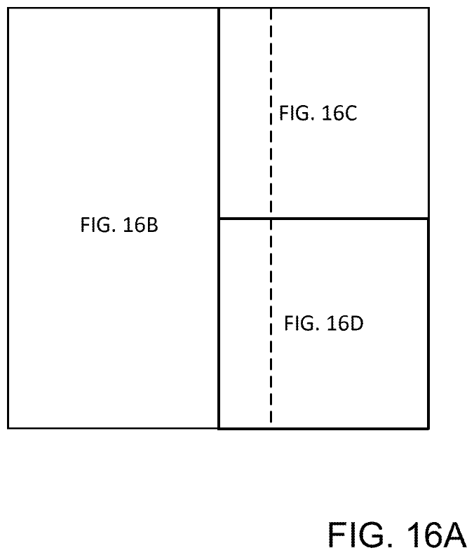

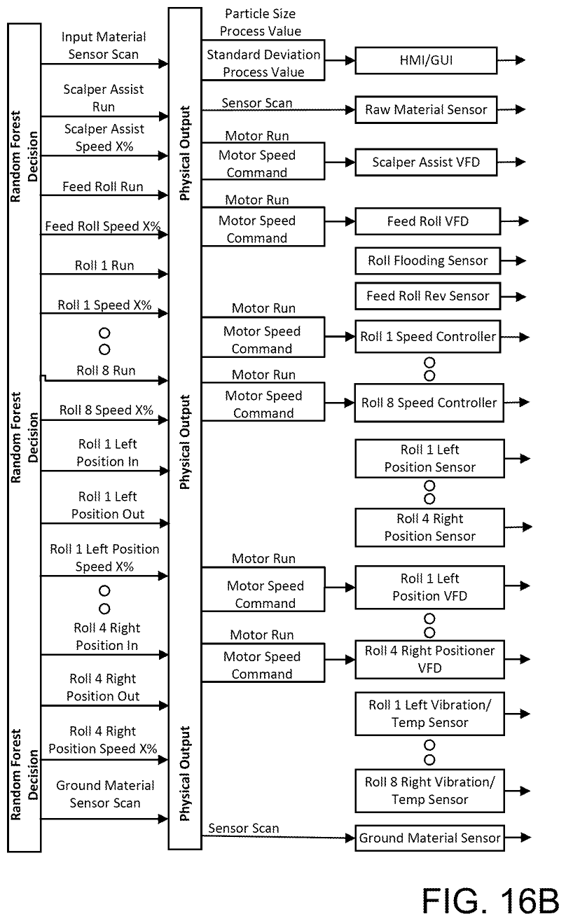

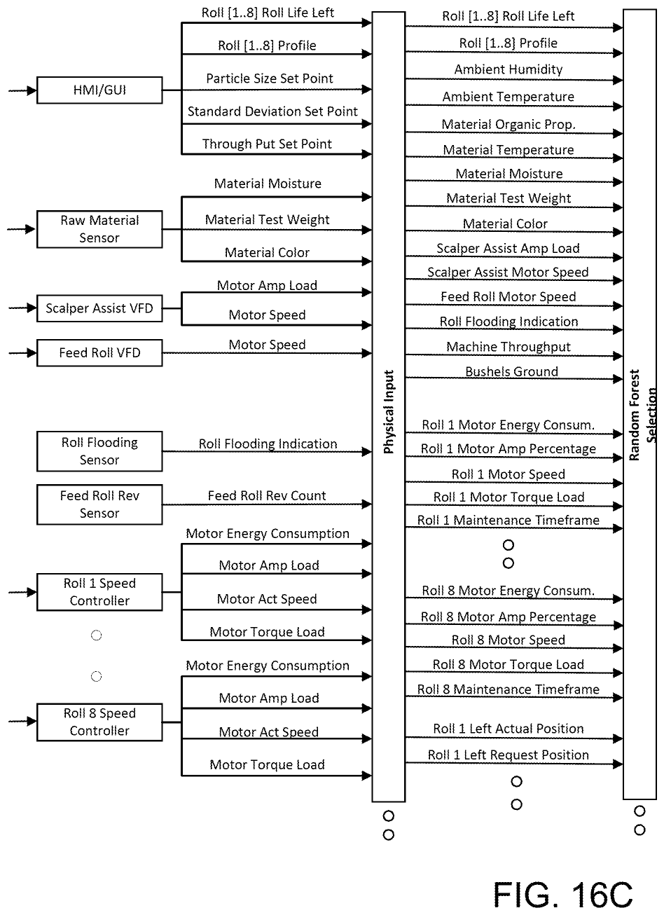

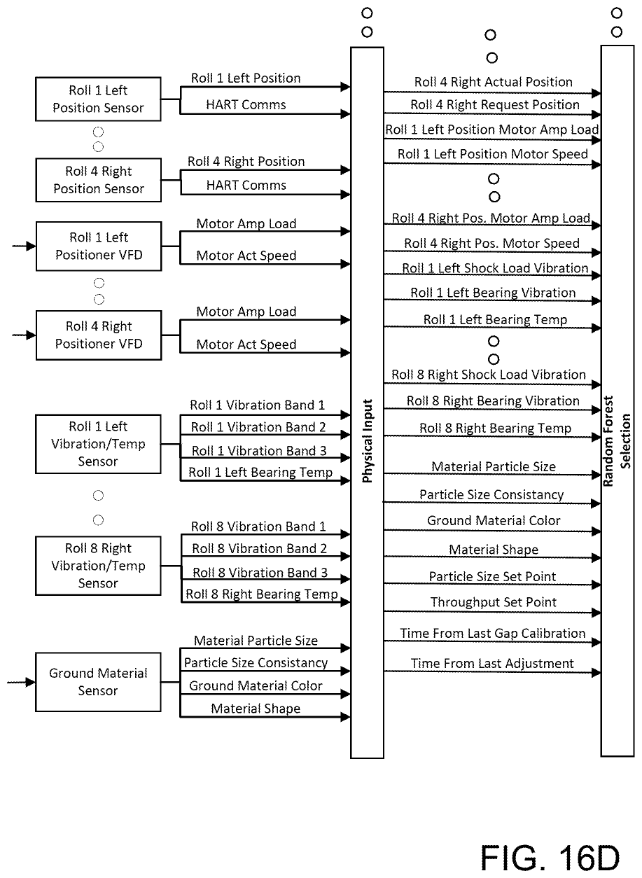

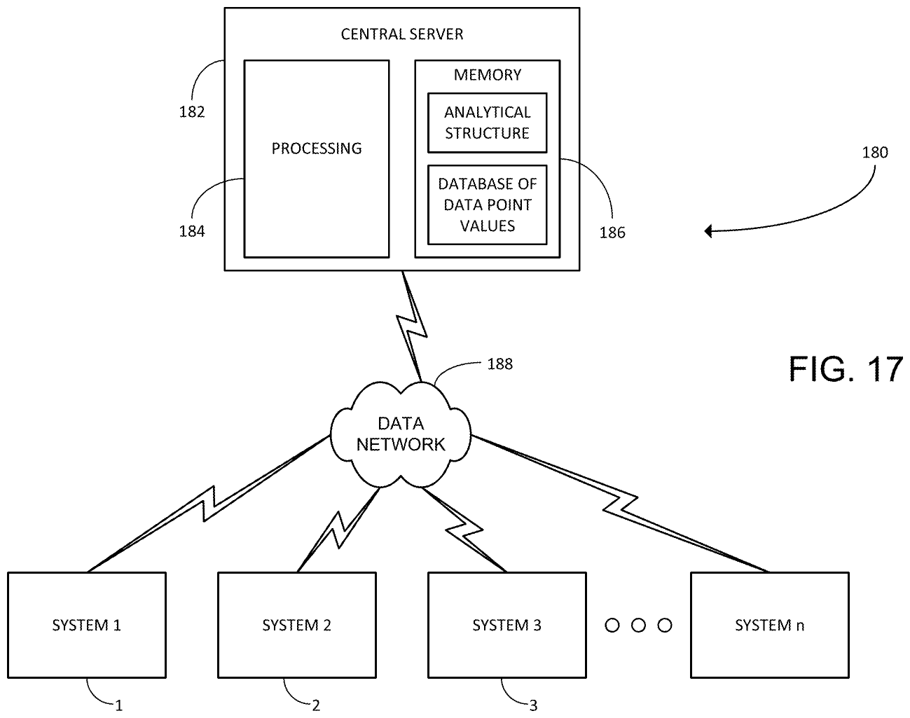

With reference now to the drawings, and in particular to FIGS. 1 through 17 thereof, a new system for grinding material incorporating machine learning embodying the principles and concepts of the disclosed subject matter will be described.

The applicants have recognized that processing particulate materials to decrease or reduce the size of the particles may involve many variables including, but not limited to, the characteristics of the material being introduced into a particle size reduction apparatus. Illustratively, in the field of grain particle size reduction, these characteristics can vary based upon factors such as growing conditions, harvesting conditions, and pre-size reduction processing of the grain. The growing conditions may include the planting time of the grain plant in the field, the growing time period of the plant in the field, the amount of moisture received by the plant, and when in the growing time that the moisture was received. The harvesting conditions may include the time of the year that the harvest occurred, as well as the weather conditions when harvesting occurred. The characteristics relating to pre-size reduction processing of the grain may include the method of drying the raw grain material for storage, such as drying in the field or drying using an artificial heat source, or some condition thereof. Often, raw grain material dried in the field will have a higher test weight than grain material dried using, for example, a grain propane dryer. Raw plant material characteristics such as the measured test weight can affect the material's friability, or the tendency of the particle of the grain material to break into smaller pieces under duress or contact, and the material's fracturability, or the tendency of the particle of grain material to fracture, crumble, crack, shatter or fail upon the application of a relatively small amount of force or impact.

The applicants have also recognized that the raw grain material received by a processing facility often originates from multiple sources (e.g., harvested from different farms) with multiple characteristic values. Thus, the raw grain material reaching the bin for the processing equipment may, in the aggregate, have grain with a wide range of characteristics. Additionally, different varieties or species of grains may be combined into a mixture that adds further variation in the characteristics of the raw material being received by the processing equipment.

The applicants have also recognized that the conventional approaches to adjusting the operational settings of the processing apparatus to the dynamic variability in the characteristic gradients of the raw material are typically reactive to the observed characteristics of the output material of the processing apparatus, and often by the time a variation in the physical characteristics of the processed material is noticed, and corresponding adjustments of the apparatus settings are made, the characteristics of the material have changed yet again. As a result of this scenario, operators of such processing apparatus will commonly take a “middle road tendency” for apparatus operational settings, an approach which in itself can cause fluctuations in the characteristics of the output material as the characteristics of the input raw material changes. In general, these changes in the characteristics of the output material can lead to losses in the operational efficiency of the apparatus.

The applicants have further recognized the advantageousness of a system capable of proactively adjusting the settings of the apparatus in real time, or virtually concurrent, with respect to the observation or sensing of the characteristics of the raw material, or partially processed (e.g., in process) material, as well as the characteristics of the material post processing,

The applicants have developed a system with capabilities of sensing material characteristics of the raw material at the input to the processing apparatus (and in some cases of the material in process on the apparatus) and adjusting operational characteristics of the apparatus as the material being processed is passing through the apparatus. The capability for adjusting multiple variables for the apparatus operation to optimize the raw material processing may be performed using advanced data analytics. These optimizations may increase the efficiencies of downstream processes such as, for example, extraction, absorption, conversions, separation, which are performed on the grain particles processed by the apparatus.

The system of the disclosure utilizes advanced data analytics concepts in analysis of the characteristics of the raw material to provide a faster response to changing characteristics of the raw material by, for example, facilitating predictions of the most suitable values for operational settings of the apparatus to optimize the physical characteristics of the output material with respect to the desired characteristics of the material. Further, the data analytics may be shared among systems so that systems without prior exposure to raw materials with particular characteristics may be able to attenuate or eliminate a learning process for handling materials with similar characteristics.

In some aspects, the disclosure relates to a system 1 for processing raw material in a manner that tends to reduce the size of the material to produce output material at the output of the system after substantially all processing has been performed on material by the system 1. In some implementations, elements of the system 1 may remove foreign matter from the raw material to produce an input material which is further processed, such as by grinding. Processing of the input material (or raw material) may produce process material which typically has received at least some processing, but also typically not all of the processing to which the output material normally receives.

In general, the system 1 may include a grinding apparatus 10 configured to physically alter the material received by the system 1, and a control apparatus 100 configured to sense various aspects of the grinding apparatus 10 and the material being processed by the system 1, and the control apparatus may also actuate or operate various elements of the grinding apparatus 10.

In embodiments of the system 1, the grinding apparatus 10 is configured to receive the raw material, grind the raw or input material (depending upon any processing conducted on the material prior to grinding), pass or transfer the process material typically having received at least some degree of grinding, and produce or output the output material. The material moves along a material processing path 12 between an input 14 of the grinding apparatus 10 and an output 16 of the grinding apparatus 10.

In some greater detail, the grinding apparatus 10 may include a frame 18 to which other elements of the grinding apparatus 10 are mounted or otherwise anchored, and may also include at least one pair of rolls 20, 22. Each pair of rolls may include a first roll 20 and a second roll 22 for the purposes of this description. It should be recognized that the grinding apparatus 10 may include a plurality of the pairs of the rolls, with the pairs of rolls typically arranged in a series along the material processing path 12 to act upon the process material as the material proceeds along the path 12. Each of the rolls may have opposite ends 24 which may include a first end and a second end. Each of the rolls 20, 22 may have a roll body 26 which has a circumferential surface, and the circumferential surface may have a substantially cylindrical shape, and a roll shaft 28 may extend into the roll body with end portions of the shaft 28 extending from the roll body to the ends 24 of the roll.

A plurality of teeth 30 may be formed on the circumferential surface of at least one, or both, of the rolls and the teeth may be configured to grind material that comes into contact with the teeth. In some embodiments, the teeth 30 may extend from one end 24 of the roll body to an opposite end of the roll body, and may be substantially continuous between the opposite ends 24, without discontinuities or breaks in the teeth. The teeth 28 may extend substantially straight between the opposite ends. A gap 32 may be formed between the circumferential surfaces of the roll bodies of the respective rolls, and between the teeth 30 on those roll bodies 26 having teeth.

In most implementations, one roll 20 of the pair of rolls may be a stationary roll mounted on the frame 18 in a manner such that the position of the roll is substantially immovable with respect to the frame, at least in the ordinary course of operation of the grinding apparatus 10. Further, one roll 22 of the pair of rolls may be a movable roll mounted on the frame 18 in a manner permitting movement of the position of the movable roll with respect to the frame, and with respect to the stationary roll 20, to adjust a size of the gap 32 between the circumferential surfaces of the rolls.

The grinding apparatus 10 may also include a plurality of roll supports 34, 36 configured to support the pair of rolls 20, 22 on the frame, with each roll support receiving one of the end portions of a roll. Illustratively, each of the roll supports 34, 36 may include a bearing. In greater detail, the plurality of roll supports 34, 36 may comprise a pair of stationary roll supports 34 which support the stationary roll of the pair of rolls. The pair of stationary roll supports 34 may engage the roll shaft 28 of the stationary roll 20, and may be configured to hold the stationary roll in a fixed position with respect to the frame 18.

The plurality of roll supports may further include a pair of movable roll supports 36 configured to support the movable roll in a manner that permits movement of the movable roll toward, and away from, the stationary roll for the purpose of adjusting the size of the gap 32. The movable roll supports 36 may be movable independent of each other to permit adjustment of the uniformity of the width of the gap 32. The pair of movable roll supports 36 engages and supports the roll shaft 28 of the movable roll, and may be movably mounted on the frame 18 to permit movement of the movable roll supported by the movable roll supports with respect to the frame.

In some embodiments, each of the movable roll supports 36 may include a bearing block 38 which is movably mounted on the frame 18. The bearing block 38 may be slidably mounted on the frame, and illustratively the bearing block may be mounted on guides on the frame which provide a track for movement of the bearing block 38 in directions generally toward and away from the stationary roll. Optionally, other means for removably mounting the bearing block on the frame may be utilized. The movable roll supports 36 may further include an adjustment structure 40 which is configured to adjust a position of the bearing block 38 with respect to the frame, and thus the position of the movable roll with respect to the stationary roll.

The grinding apparatus 10 may further include at least one rotation motor 42 mounted on the frame 18 and being configured to rotate at least one of the rolls 20, 22 of the pair of rolls. In some embodiments, a pair of the rotation motors may be utilized, with a first rotation motor 42 and a second rotational motor 44, and each rotation motor is configured to rotate a respective roll of the pair of rolls. The pair of rotation motors 32, 44 may be configured to rotate the pair of rolls independently of each other such that the rolls of a pair are rotatable at similar or different rotational speeds with respect to each other.

The grinding apparatus 10 may further include a scalper apparatus 46 which receives raw material, such as from the input 14, and may be configured to separate foreign matter from a remainder of the raw material, which may form the input material for the material processing path. The scalper apparatus 36 may separate the raw material into a first flow of the input material to continue along the material processing path 12, and a second flow of the foreign matter to be discarded. In some embodiments, the scalper apparatus 46 may comprise a housing 48 which has an interior, a grate 50 positioned in the interior of the housing. The grate 50 may be substantially horizontally oriented with a slight slope, and may comprise a plurality of bars which may be oriented substantially parallel to each other and each of the bars may be spaced from at least one adjacent bar to form an elongated gap between the adjacent bars.

The scalper apparatus 46 may further include a material movement element for moving the material with respect to the scalper apparatus, and illustratively may include a paddle assembly 52 configured to move material entering the scalper apparatus along the grate 50, and the paddle assembly may be located in the interior of the housing 48. The paddle assembly 52 may include a plurality of paddles 54 movable across the grate 50, and a carrier assembly 56 configured to carry the plurality of paddles across the grate. The scalper apparatus 46 may further include a scalper drive motor 58 configured to drive the carrier assembly to move the plurality of paddles across the grate.

The grinding apparatus 10 may further include a feed apparatus 60 which is configured to handle input material moving on the material processing path 12. The feed apparatus 60 may be configured to control a feed rate of the input material moving along the path 12 and generally through elements of the system 1 in the path 12 after the feed apparatus. The input material may be received by the feed apparatus 60 from the scalper apparatus 46.

In greater detail, the feed apparatus 60 may include a feed apparatus housing 62 which defines a feed housing interior, a feed rotor 64 which is positioned in the feed housing interior and rotates to move material through the feed housing interior. The feed rotor 64 may comprise a rotating shaft 66 rotatably mounted on the feed apparatus housing, and a plurality of vanes 68 extending substantially radially outwardly from the rotating shaft to rotate the shaft with respect to the feed apparatus housing. Further, a trough wall 70 may be positioned adjacent to the feed rotor, and may have a curved shape to form a trough for receiving or catching the input material moving along the material processing path 12, such that rotation of the feed rotor 64 tends to move the input material out of the trough to continue along the path 12. A feed motor 72 of the feed apparatus 60 may be configured to rotate the feed rotor 64, and may be connected to the rotating shaft 66 on the rotor 64 in a suitable matter in order to transfer the rotation of the motor shaft to the rotating shaft 66.

The control apparatus 100 of the system 1 may be configured to facilitate control of the operation of the grinding apparatus 10, by, for example, sensing or detecting various conditions relating to the operation or status of the grinding apparatus as well as various characteristics of the material at one or more phases of the processing of the material by the system 1. In general, the control apparatus 100 may include sensors or detectors for sensing or detecting the various conditions of the grinding apparatus as well as characteristics of the material entering, leaving, or moving along the material processing path, and may also include actuators or controllers for actuating or controlling operation of elements of the system 1, such as elements of the grinding apparatus 10.

In some embodiments, the control apparatus 100 may include an operational interface assembly 102 configured to provide an interface for operating the system 10. In some implementations, the operational interface assembly 102 may enable operation of aspects of the system by a human operator, and may include human machine interface elements to facilitate communication of information between the operator and the system 1. The operational interface assembly 102 may be utilized to present machine process values in a manner perceptible and understandable to the operator. The operational interface assembly 102 may further be configured to receive inputs from the operator, such as, for example, adjustments from the operator to machine set points. In some embodiments, the operational interface assembly 102 may utilize graphical user interface (GUI) elements. In some implementations, the operational interface assembly 102 may permit operational control to be exercised by non-human elements, such as other control elements external to the system 10. The non-human control elements may communicate with the interface assembly 102 via an application programming interface (API) which may receive control commends from, for example, a master or global control system which may control elements beyond system 10 upstream and/or downstream from the system 10. Such upstream and/or downstream elements may provide, for example, initial storage or additional processing of the material.

In greater detail, the operational interface assembly 102 may include a display screen 104 for displaying for information such as characters, images, etc., and an input device 106 for accepting operator input, such as touch sensitive screen (optionally integrated with the display screen 104), a keyboard, a mouse, a memory device, or even an interface to a data network. The interface assembly 102 may further include a particle size control 108 configured to receive a particle size set point value for the system from the operator, via, for example, the input device 106. In some implementations, a set point for the particle size control 108 may be received from another source, such as, for example, a device associated with the raw or input material (e.g., a device involved in handling the material prior to the material being received by the system) or a device associated with the output material (e.g., a device involved in handling the material after it leaves the system). The particle size control 108 may be adjustable to adjust the particle size set point for the system 1. Illustratively, a value assigned to the particle size set point may represent the desired or target average physical size of the particles of the output material, or in some cases the process material, moving along the material processing path 12. The interface assembly 102 may also include a particle standard deviation control 110 configured to receive a standard deviation set point value for the system from the operator, such as by means of the input device 106. Again, in some implementations, a set point for the particle standard deviation control 110 may be received from another source, such as, for example, a device associated with the material prior to or after processing by the system. The particle standard deviation control 110 may be adjustable to adjust the standard deviation set point value for the system 1. Illustratively, a value assigned to the standard deviation set point via the particle standard deviation control 110 may represent the desired or target consistency of the physical size of the output material or process material measured along the processing path 12. The interface assembly 102 may still further include a particle throughput control 112 configured to receive a throughput set point for the system from the operator, such as via the input device 106. In implementations, a set point for the particle throughput control 112 may be received from another source, such as, for example, a device associated with the material prior to or after processing by the system. The particle throughput control 112 may be adjustable to adjust the throughput set point for the system 1. Illustratively, a value assigned to the throughput set point via the particle throughput control 112 may represent the desired or target throughput, or rate, of material moving through the system 1 via the processing path 12, of the material.

The control apparatus 100 may also include a sensor assembly 120. The sensor assembly 120 may be configured to sense operational characteristics of elements of the system 1, and the sensing of the operational characteristics may produce machine data. The sensor assembly 120 may also be configured to sense physical characteristics of the material processed, or being processed, by the system 1, and the sensing of the physical characteristics may produce material data. The sensor assembly 120 may comprise at least one input material sensor 122 which is configured to sense at least one physical characteristic of the input material being received by the input 14 of the grinding apparatus 10. The characteristic, or characteristics, of the input material may be measured in a sample of the input material. The sample of the input material may be material passing through a first location on the material processing path 12, such as at the input 14, over a time period.

In some implementations of the system 1, the input material sensor 122 may be configured to sense a moisture characteristic of the input material, and the moisture characteristic may be measured as a concentration of moisture in the sample of the input material. In some embodiments, the input material sensor 122 for sensing the concentration of moisture may comprise a spectroscopy device to sense the concentration of moisture in the sample.

In implementations of the system 1, the input material sensor 122 may be configured to sense a weight characteristic of the input material, and the weight characteristic may be measured as a density of a sample of the input material. The density of the sample may be measured at a reference moisture level, and the weight characteristic may take into consideration the concentration of moisture of the material as indicated by value of the moisture characteristic. In some embodiments, the input material sensor 122 for sensing the weight characteristic may comprise a flow scale device to sense a weight of the input material, such as when the input material is moving over the scale device.

In further implementations of the system 1, the input material sensor 122 may be configured to sense a color characteristic of the input material, and the color characteristic may be measured as a color of the sample of the input material. The color of the material may be represented by a value representing an overall color of the sample of the input material. The input material sensor 122 may comprise an image capture device for capturing an image of the input material to sense the color characteristic of the input material.

In still further implementations, the input material sensor 122 may be configured to sense an organic characteristic of the input material. Illustratively, the organic characteristic may comprise an overall protein level of the sample of the input material. As a further illustration, the organic characteristic may comprise an overall fat level present in the sample of the input material. As another illustration, the organic characteristic may comprise an overall ash level present in the sample of the input material.

The sensor assembly 120 may further include a feed apparatus operation sensor 126 for sensing a characteristic of the operation of the feed apparatus 60. The feed apparatus operation sensor 126 may sense rotation of the feed rotor 64 to generate a rotation count signal corresponding to a number of rotations (over a period of time) of the feed rotor sensed by the feed apparatus operation sensor. The rotation count value may be useful, for example, in determining the remaining life of the rolls 20, 22 of the grinding apparatus 10 by providing an indication of the volume of material processed by the rolls.

The sensor assembly 120 may also include a material flooding sensor 130 for sensing a saturation of input material at a location prior to the pair of rolls 20, 22 along the material processing path 12. The material flooding sensor 130 may sense an excess quantity or accumulation of input material at a location along the material processing path, and the excess quantity may comprise or be defined as a quantity above a predetermined threshold quantity. Sensing an excess quantity of input material may trigger a reduction in the feed rate of the material to reduce the excess quantity resulting in the material flooding, and beneficially minimizing exposure of the rolls to the saturation of input material which may prematurely dull the sharpness of the teeth of the rolls due to increased contact points between the teeth on the roll and the input material.

The sensor assembly 120 may include a roll position sensor 134 for sensing a position of at least one roll of the pair of rolls 20, 22, such as the position of the movable roll 22 with respect to a predetermined point. The predetermined point may be a zero point at which the width of the gap 32 between the rolls 20, 22 is substantially equal to zero. The roll position sensor 134 may include a pair of roll position sensors 134, 136, with each roll position sensor being configured to sense a position of one of the ends 24 of the particular roll. The roll position sensors 134, 136 may be positioned on a movable element of the movable roll support to move with the end 24 of the roll. A first roll position sensor 134 may be associated with a first end of the roll and a second roll position sensor 136 may be associated with a second end of the roll. In some implementations, the roll position sensor or sensors may be configured to sense additional operational characteristics of the roll or associated elements, such as, for example, an ambient temperature of the environment of the grinding apparatus.

The sensor assembly 120 may further include a roll characteristic sensor 140 that may be configured to sense at least one characteristic of a roll with which the roll characteristic sensor is associated. The roll characteristic sensor 140 may be in communication with one of the roll supports 34, 36 associated with the roll. The roll characteristic sensor 140 may be mounted in a manner so as to be positioned close to a bearing supporting the associated roll. For example, the roll characteristic sensor 140 may be mounted on the bearing block 38 of the roll support.

In some implementations, the characteristic of the roll may comprise a level of vibration experienced by the bearing of the roll support, and vibration may be represented by detection of at least one characteristic vibration frequency of any vibration experienced by the roll characteristic sensor associated with the bearing. The characteristic vibration frequency sensed by the roll characteristic sensor 140 can be compared to various predetermined vibration frequencies typically associated with events affecting the performance and operation of the grinding apparatus 10, such as, for example, one or more vibration frequencies typically associated with the failure of the bearing of the associated roll support. Other predetermined vibration frequencies may be those typically associated with the passage of foreign material through the gap and impacting at least one of the rolls to cause displacement of the roll (as may be permitted by structure provided to minimize damage to the rolls from foreign material passing to the gap).

In some implementations, the characteristic of the roll may comprise a temperature of the bearing of the roll support, which may be compared against a temperature, or range of temperatures, typically associated with failure or impending failure of the bearing or, conversely, a normal or typical operating range of temperatures.

The sensor assembly 120 may include sensors directed to the material being processed, and may include a process material sensor 144 for sensing at least one characteristic of the material processed by the system. In some implementations, the process material sensor 144 may be configured to sense the characteristic or characteristics of the process material as the process material moves along the material processing path 12, such as after some processing has been performed on the material but the material may receive further processing. In some implementations, the process material sensor 144 may be configured to sense a characteristic or characteristics of the output material at the output 16 of the apparatus 10, such as when all processing of the material has been completed. In greater detail, the characteristic of the material may include at least one characteristic selected from the list of characteristics including particle size for use in the determination of particle size consistency, the color of the material, and the shape of the particles of the material (in terms of sphericity or roundness), as well as other characteristics of the material.

In some embodiments, the process material sensor 144 may comprise at least one camera 148 which is configured to capture an image, or series of images, of particles of the material being sensed by the process material sensor. Images from the camera 148 may be utilized in sensing or measuring particle characteristics such as, for example, particle size of the material, color of the material, and shape of the particles. Other characteristics of the particles of the material may also be sentenced utilizing images from the camera 148.

Elements of the control apparatus 100 relating to the operation or status of the grinding apparatus 10 may comprise an actuating assembly 150 configured to actuate or operate elements of the system 1. In some embodiments of the system 1, the actuating assembly 150 may include a rotation motor speed controller 154 for controlling operation of a rotation motor 42, 44 that rotates a corresponding roll 20, 22 of the grinding assembly. The rotation motor speed controller 154 may be configured to control aspects of the power supplied to the rotation motor to control the rotational speed of the rotation motor.

Additionally, the rotation motor speed control 154 may receive information from the associated motor regarding the loading of the motor. The rotation motor speed controller 154 may be configured to sense at least one characteristic of the operation of the rotation motor, such as, for example, the electrical power usage by the rotation motor. In some embodiments, the rotation motor speed controller 154 may include energy measurement devices to measure electrical power usage by the rotation motor, and the energy measurement devices may include, for example, at least one current transformer and at least one voltage transformer. Illustratively, the rotation motor speed controller 154 may comprise a variable frequency driver (VFD) control. Information regarding the loading of the rotation motor may serve as a basis for estimating torque values and slip calculations associated with the motor.

The control apparatus 100 may further include a scalper motor speed controller 160 for controlling the scalper drive motor 58 of the scalper apparatus 46 in order to adjust a rotational speed of the scalper drive motor, and thereby affect the movement of the material through the scalper apparatus. The scalper motor speed controller 160 may be configured to sense a power draw characteristic of the drive motor 58, such as by sensing the amperage load of the scalper drive motor 58. Illustratively, the scalper motor speed controller 160 may comprise a variable frequency driver (VFD) control. Information regarding the power draw of the motor speed controller 160 may serve as a basis for determining how much foreign matter may be present in the raw material, as the presence of foreign matter in the raw material tends to increase the load on the scalper drive motor.

The control apparatus 100 may also include a feed motor speed controller 166 for controlling operation of the feed motor 72 of the feed apparatus 60, and the speed controller 166 may be configured to sense a rotation speed of the feed rotor 64. Illustratively, the feed motor speed controller 166 may comprise a variable frequency driver (VFD) control;

Further, the control apparatus 100 may include a roll positioning assembly 170 for adjusting a position, or a part of the position, of a roll and as a result may adjust the size of the gap 32 between the rolls. The roll positioning assembly 170 may be configured to engage the movable roll support 34 supporting the movable roll 22 in order to move the movable element of the movable roll support.

In some implementations, a pair of the roll positioning assemblies 170 may be utilized, with each assembly 170 being associated with one movable roll support 34 of the pair of movable roll supports, such that the ends of the movable roll 22 may be adjusted substantially independent of each other to facilitate the truing up of the position of the roll to produce a gap 32 of substantially uniform width between the rolls. Illustratively, each roll positioning assembly 170 may include a positioning actuator 172 which engages the movable element of the movable roll support to move the movable element, a positioning motor 174 configured to operate the positioning actuator 172, and a positioning motor controller 176 configured to control operation of the positioning motor. The positioning motor controller 176 may be configured to sense a current load represented by the positioning motor 174, and the positioning motor controller will also be configured to sense a rotation speed of the positioning motor. Illustratively, the positioning motor controller may comprise a variable frequency drive (VFD) motor control.

The control apparatus 100 may also include a processing device 178 configured to receive signals from various sources, such as the operational interface assembly 102 and elements of the sensor assembly 120 and elements of the actuating assembly 150. Further, the processing device 178 may be configured to send signals to the operational interface assembly 102 and other elements of the control apparatus 100, including elements of the actuating assembly 150.

In some aspects of the disclosure, an analytical structure, which may be executed by the processing device, may be employed for receiving data relating to values sensed or otherwise detected for the various data points (e.g., process values) monitored by elements of the control apparatus 100 of the system 1. The analytical structure may recommend or implement values for the various set points for the elements of the control apparatus 100, and by extension, the elements of the grinding apparatus 10, of the system 1 in order to optimize the operation of the grinding apparatus and facilitate achievement of the desired characteristics of the output material.

An advantage of the analytical structure is that data gathered from past operation of the grinding apparatus 10 may be utilized to improve the accuracy of the output of the analytical structure for determining set point values, and the accumulation of further (e.g., future) data may be utilized to make further improvements or refinements to the analytical structure. Aspects of the analytical structure may be executed by the processing device 180, as well as other elements of the control apparatus 100. Further, a training system utilized for training and improving the analytical structure may be located on a central server which maintains a database available to receive data point values from multiple systems 1 and apply the data point values to the analytical structure to improve the analytical structure based upon the data from multiple systems, rather than being limited to data from a single system or even multiple systems of a single facility. In turn, the analytical structure developed from the data points received from the multiple systems may be shared with or transmitted to the individual systems so that the refinements to the analytical structure can be applied by each of the individual systems.

In an illustrative implementation of the disclosure, an information sharing structure 180 may be provided which is configured to communicate information between a plurality of the systems 1, 2, 3, etc. Optionally, the structure 180 may also be configured to provide various degrees of control of the constituent systems by external systems or elements. Illustratively, the information sharing structure 180 may be in communication with the processing devices 178 of the individual systems 1, 2, 3. The plurality of systems 1, 2, 3 may have geographically diverse locations. As an example, the location of the system 1 may be geographically remote from the location of the system 2, such as being separated by miles or kilometers between each other. As a further example, the location of the system 3 may be geographically close to the location of the system 2, such as in the same facility.

The information sharing structure 180 may also be configured to communicate information such as data, processing models, and the like from one of the systems to one or more of the other systems to facilitate the operation of one or more of the systems. The communicated information shared to the server 182 and the connected systems 1, 2, 3 may include information regarding the analytical structure developed by one or more of the systems and may include data point values recorded by systems of the information sharing structure. One function that may be implemented with the sharing of information and processing models may include data mining of the data point values of the individual systems which may have been derived from the operation of the systems. Another function that may be implemented may be the optimization of the settings of one system based upon settings utilized by another system under similar conditions of operation, particularly when the recipient system lacks prior experience with conditions of the operation now being experienced, and may be executed by the system without human intervention. As an example, if a grinding apparatus of a system needs to grind grain to a size that has not been performed on that apparatus before, or under conditions (such as moisture content) not encountered before, apparatus settings may be communicated to the inexperienced apparatus by an experienced apparatus. Further optimization of the apparatus settings could occur based upon the communicated settings.

The information sharing structure 180 may include a central server 182 which may form a central point in a logical sense for the sharing of information between the systems 1, 2, 3, etc. In embodiments, the central server 182 may have a processing capability provided by a processing element 184 and an information storage capability provided by a memory element 186. The central server 182 may be in communication with a communication network 188. In some embodiments, the central server 182 may not be directly associated with any of the systems.

The information sharing structure 180 may further include a communication interface 190 associated with each of the systems 1, 2, 3. The communication interfaces may each be in communication with the central server 182, and may communicate with server 182 via the communication network 188. To facilitate communication, each communication interface 190 may be in communication with the processing device 178 of the respective system. The communication interface 190 of a system may be configured to transmit information (e.g., data point values) to the central server 182, and the server 182 may be configured to collect the information received from the plurality of systems 1, 2, 3 for storage of the information, and optionally the server 182 may perform some degree of processing of the received information. The central server 182 may also be configured to transmit information to at least one of the systems to be received by the communication interface 190 of the target system.

In one implementation, the analytical structure utilizes an artificial neural network (ANN) modeling technique for refining operation of the system. During operation of the system 1, the data points or process values received from the sensor assembly as well as set point values may be communicated to the input layer of an artificial neural network (ANN) module of the analytical structure for analyzing and refining the processing and manipulation of the values utilized for the set points for the system 1. Each data point may be assigned to a “neuron” of the analytical structure where a mathematical treatment may be applied to the data point based on the results (e.g., output) of previous analysis of earlier captured data points used to bring the achieved value of the process value closer to the desired value for the set point.

Each neuron of the analytical structure may be associated with a weight value and a bias value that may be applied to the data point process value from the input. After the weight and bias functions are applied to the process value of the data point, the value of the data point may be processed using an activation function which provides a value, such as a value in the range of 0 to 1. The values derived from the application of the weight and bias functions (e.g., at the output layer of the ANN) may affect an input into a first hidden layer in which the same or similar processing is repeated until the process data value is provided to the output layer.

The model applied to the data points may be illustrated using matrix multiplication as follows:

$$σ ( [ \begin{matrix}{w}_{0 , 0} & {w}_{0 , 1} & {w}_{0 , 2} & … & {w}_{0 , n} \\ {w}_{1 , 0} & {w}_{1 , 1} & {w}_{1 , 2} & … & {w}_{1 , n} \\ {w}_{2 , 0} & {w}_{2 , 1} & {w}_{2 , 2} & … & {w}_{2 , n} \\ ⋮ & ⋮ & ⋮ & ⋱ & ⋮ \\ {w}_{k , 0} & {w}_{k , 1} & {w}_{k , 2} & … & {w}_{k , n}\end{matrix} ] [ \begin{matrix}{a}_{0}^{( 0 )} \\ {a}_{1}^{( 0 )} \\ {a}_{2}^{( 0 )} \\ ⋮ \\ {a}_{n}^{( 0 )}\end{matrix} ] + [ \begin{matrix}{b}_{0} \\ {b}_{1} \\ {b}_{2} \\ ⋮ \\ {b}_{n}\end{matrix} ] )$$

### Where:

$$σ ( \text{?} ) - \frac{1}{1 + \text{?}} \\ \text{?} \text{indicates text missing or illegible when filed}$$

w—Weight of Current Layer
a—Activation layer
b—bias of function

At the output layer, the activation value having the greatest magnitude (e.g., on the 0 to 1 scale) may determine the recommended machine adjustment to the value of the set point to achieve optimization of the data point, and the machine adjustment may be communicated by the module to the elements of the processor controlling the subject adjustment. In some implementations, “Fuzzy Logic” may be applied such that values of the activation value relatively closer to the value of 1 may result in larger increases in the value of the set point, while values of the activation value closer to 0 may result in smaller increases in the value of the set point.

In a training mode of the analytical structure, if the process value at the output layer moves further away from the set point, the ANN may utilize a feedback loop on the ANN model through a “Cost Function” which may be used to adjust the weights and biases applied in the model based upon the most recent activation values utilized in the model.

Utilization of the cost function may help the ANN model determine which neurons may benefit from an adjustment of the weights and/or biases to enhance the accuracy of the results, such as by mathematically determining which adjustments are likely to have the largest impact in causing the process value to approach the set point. One technique, often referred to as gradient descent, involves finding a local minimum of the cost function. Data sets in which the difference between the process value and the set point are the largest may be prioritized as larger differences may have the largest gradient descent possibility.

The model training processor may update the weights and/or biases associated with the neurons.

$$- \text{?} C ( \overline{w} ) = [ \begin{matrix}{w}_{0} \\ {w}_{1} \\ {w}_{2} \\ ⋮ \\ {w}_{n}\end{matrix} ] \\ \text{?} \text{indicates text missing or illegible when filed}$$

The chain rule for cost function of the weights:

$$\frac{\partial {C}_{0}}{\partial {w}^{( L )}} = \frac{\partial {z}^{( L )}}{\partial {w}^{( L )}} \frac{\partial {a}^{( L )}}{\partial {z}^{( L )}} \frac{\partial C 0}{\partial {a}^{( L )}} = {a}^{( L - 1 )} {σ}^{1} ( {z}^{( L )} ) 2 ( {a}^{( L )} - y )$$

The chain rule for cost function of the bias:

$$\frac{\partial {C}_{0}}{\partial {b}^{( L )}} = \frac{\partial {z}^{( L )}}{\partial {b}^{( L )}} \frac{\partial {a}^{( L )}}{\partial {z}^{( L )}} \frac{\partial C 0}{\partial {a}^{( L )}} = 1 {σ}^{1} ( {z}^{( L )} ) 2 ( {a}^{( L )} - y )$$

### Where:

c₀=(a^{(L)}−y)²

z^{(k)}=w^{(L)}a^{(L-1)}+b^{(L)}

a^{(L)}=σ(z^{(L)})

In another implementation, the analytical structure utilizes a random forest selection and tree modeling technique for refining operation of the system. During operation of the system 1, the input data values may be transferred to a random forest selection module of the analytical structure in which a set of decision trees may run a selection model based on computer guided decisions to help split the determination to help adjust the variable that will get the process value of the data point to the set point.

For example, the decisions may start out more general in nature, such as, for example:

Is the particle size (PS) within the desired (set) range?

Gradually, the decisions may become more in-depth, such as, for example:

### Is the [PS.PV−PS.SP]>50?

(Or, is the difference between the particle size process value (sensed size value) and the particle size set point (desired size setting) greater than 50 units?)

The decisions may become even more in-depth, such as, for example:

Is the motor1.ampload>motor3.ampload?

(Or, is the power draw of motor 1 greater than the power draw of motor 3?)

The tree model may make a recommendation based upon on the output designed to bring the sensed process value closer to the set point value.

Each recommendation of the tree model may be run through the decision function in which the data inputs may be averaged in a mean, mode, or other math treatments to make a final decision. The final decision may be output to the processing device to execute by the control apparatus.

Training of the random forest and tree model may utilize a technique referred to as induction may be utilized to train the model, and may rely upon a manual approach to help the model determine the best data to utilize and adjust. Overall this can be taken from typical operators behaviors such as:

If PS.PV>PS.SR, then Gap Position 3.5P-2

By understanding the relationship between PS.PV and PS.SP and how the gap 32 of the grinding apparatus needs to be adjusted, the model can “take the shortest path” to run the model (which may increase computation speed by keeping the model lean and taking less processing power to run).

Another technique for training the tree model is referred to as “pruning.” Similar to the mechanical process of pruning a tree where branches are removed, braches of the decision tree may be removed in situations where it is determined that no further decision branches are needed in order to come to the final output. Such as the statement:

If PS.PV=PS.SP, then Decision Output Changes=0

Clearly, it is unnecessary for the above statement to be executed by further logic as the statement satisfies the recommended changes to the machine outputs.

It should be appreciated that in the foregoing description and appended claims, that the terms “substantially” and “approximately,” when used to modify another term, mean “for the most part” or “being largely but not wholly or completely that which is specified” by the modified term.

It should also be appreciated from the foregoing description that, except when mutually exclusive, the features of the various embodiments described herein may be combined with features of other embodiments as desired while remaining within the intended scope of the disclosure.

Further, those skilled in the art will appreciate that steps set forth in the description and/or shown in the drawing figures may be altered in a variety of ways. For example, the order of the steps may be rearranged, substeps may be performed in parallel, shown steps may be omitted, or other steps may be included, etc.

In this document, the terms “a” or “an” are used, as is common in patent documents, to include one or more than one, independent of any other instances or usages of “at least one” or “one or more.”

In this document, the term “or” is used to refer to a nonexclusive or, such that “A or B” includes “A but not B,” “B but not A,” and “A and B,” unless otherwise indicated.

With respect to the above description then, it is to be realized that the optimum dimensional relationships for the parts of the disclosed embodiments and implementations, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present disclosure.

Therefore, the foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that fall within the scope of the claims.

We claim:

1. A system comprising:
a grinding apparatus configured to receive material and produce the output material, the grinding apparatus comprising
a frame;
at least one pair of grinding rolls;
a plurality of roll supports configured to support the at least one pair of rolls on the frame;
at least one rotation motor configured to rotate at least one of the rolls of the at least one pair of rolls; and
a control apparatus configured to control operation of elements of the system, the control apparatus comprising:
an operational interface assembly configured to provide an operational interface for the system;
a sensor assembly configured to sense operational characteristics of elements of the system to produce machine data, the sensor assembly being configured to sense physical characteristics of the material processed by the system to produce material data;
an actuating assembly configured to operate elements of the system; and
a processing device configured to receive input from the operational interface assembly and the sensor assembly and send output to the actuating assembly, the processing device being configured to apply an analytical structure to input received by the processing device and to generate output to affect operation of the elements of the system.

2. The system of claim 1 wherein the grinding apparatus additionally comprises a scalper apparatus configured to receive raw material input into the system, scalper apparatus including a material movement element and a drive motor connected to the material moving element to move the raw material with respect to the scalper apparatus; and
wherein the actuating assembly of the control apparatus additionally comprises a motor control configured to control a rotational speed of the drive motor, the motor control being additionally configured to sense an amperage load of the drive motor.

3. The system of claim 1 wherein the grinding apparatus additionally comprises a feed apparatus configured to feed input material at an input of the grinding apparatus, the feed apparatus including a feed rotor rotatable to move material through the feed housing interior; and a feed motor configured to rotate the feed rotor; and
wherein the actuating assembly of the control apparatus additionally comprises a motor control configured to control a rotational speed of the feed motor.

4. The system of claim 3 wherein the sensor assembly of the control apparatus comprises a feed apparatus operation sensor configured to sense a characteristic of the operation of the feed apparatus, the feed apparatus operation sensor being configured to sense rotation of the feed rotor to generate a rotation count signal corresponding to a number of rotations of the feed rotor.

5. The system of claim 1 wherein the actuating assembly of the control apparatus additionally comprises a motor controller configured to control power supplied to the at least one rotation motor to control a rotational speed of the at least one rotation motor.

6. The system of claim 1 wherein the sensor assembly of the control apparatus comprises at least one input material sensor configured to sense at least one physical characteristic of input material being input into the system.

7. The system of claim 6 wherein the sensor assembly of the control apparatus comprises a process material sensor configured to sense at least one characteristic of material at least partially processed by the system.

8. The system of claim 7 wherein the process material sensor comprises at least one camera configured to capture an image of particles of the material being sensed by the process material sensor.

9. The system of claim 1 wherein the sensor assembly of the control apparatus comprises a material flooding sensor configured to sense a saturation of input material at a location prior to the pair of grinding rolls along a material processing path.

10. The system of claim 1 wherein the sensor assembly of the control apparatus comprises a roll characteristic sensor configured to sense at least one characteristic of a said roll with which the roll characteristic sensor is associated.

11. The system of claim 10 wherein the roll characteristic sensor is in communication with one of the roll supports associated with the said roll.

12. The system of claim 1 wherein the sensor assembly of the control apparatus comprises a roll position sensor configured to sense a position of at least one roll of the pair of rolls; and
wherein the actuating assembly of the control apparatus comprises a roll positioning assembly configured to adjust a position of at least one of the rolls of the pair of rolls.

13. The system of claim 1 wherein the sensor assembly of the control apparatus comprises a grinding roll speed controller configured to control operation of a said rotation motor rotating a corresponding roll.

14. In combination:
a plurality of systems, each system comprising:
a grinding apparatus configured to receive material and produce the output material, the grinding apparatus comprising
a frame;
at least one pair of grinding rolls;
a plurality of roll supports configured to support the at least one pair of rolls on the frame;
at least one rotation motor configured to rotate at least one of the rolls of the at least one pair of rolls; and
a control apparatus configured to control operation of elements of the system, the control apparatus comprising:
an operational interface assembly configured to provide an operational interface for the system;
a sensor assembly configured to sense operational characteristics of elements of the system to produce machine data, the sensor assembly being configured to sense physical characteristics of the material processed by the system to produce material data;
an actuating assembly configured to operate elements of the system; and
a processing device configured to receive input from the operational interface assembly and the sensor assembly and send output to the actuating assembly, the processing device being configured to apply an analytical structure to input received by the processing device and to generate output to affect operation of the elements of the system; and
an information sharing structure configured to communicate information between at least two of the systems of the plurality of systems, the information sharing structure including:
a central server in communication with a communication network; and
a communication interface associated with each of the systems, each of the communication interfaces being in communication with the central server via the communication network;
wherein the information communication structure is configured to permit sharing of aspects of the analytical structure between the at least two systems.
